(19) United States
(12) Patent Application Publication
(10) Pub. No.: US 2010/0300132 A1
(43) Pub. Date: Dec. 2, 2010

(54) FIBRE ASSEMBLIES AND USE THEREOF IN VACUUM INSULATION SYSTEMS

(75) Inventors: Thorsten Schultz, Hassenroth (DE); Herbert Griesser, Voecklabruck (AT); Georg Markowz, Alzenau (DE); Ruediger Schuette, Alzenau-Hoerstein (DE); Hans-Peter Ebert, Dettelbach (DE); Matthias Geisler, Wuerzburg (DE); Johannes Wachtel, Lohr am Main (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/733,673

(22) PCT Filed: Aug. 15, 2008
(86) PCT No.: PCT/EP2008/060729

§ 371 Date: Jun. 28, 2010

(30) Foreign Application Priority Data
Sep. 14, 2007 (DE) 102007043946.8

(51) Int. Cl. F25D 31/00; B32B 5/02; F24H 9/00

(52) U.S. Cl. 62/259.1; 428/221; 428/338; 165/47

(57) ABSTRACT

The present invention relates to a fibre assembly comprising high-performance polymeric fibres and bonding fibres, the fibre assembly comprising at least 70% by weight of high-performance polymeric fibres and at most 30% by weight of bonding fibres, the fibre assembly having a layered arrangement of the fibres and at least some of the fibres being bonded together by points of contact obtainable by softening of the bonding fibres. The present invention further describes an insulation system comprising a fibre assembly of the invention.

The present invention relates to a fibre assembly which may preferably be used in vacuum insulation systems. The present invention further describes insulation systems comprising a fibre assembly of the present invention and also the use of high-performance polymeric fibres.

As fossil sources of energy become scarcer and the need for measures to control global warming becomes more acute, energy-saving technologies and the economical transportation of energy and also the interim storage of useful energy generated in a resource-preserving manner gain increasing importance. A promising alternative for this supplementation and remodelling of the fossil energy economy is the use of cryogenic energy media, for example an ecological hydrogen economy.

The demand for effective thermal insulation materials is therefore rising in all these fields. Specifically extended cryo infrastructures can only be operated economically when the inevitable losses of heat to the environment are severely curtailed by excellent thermal insulation.

Line systems for transporting cold liquids are described inter alia in DE-A-31 03 587, DE-A-36 30 399, EP-A-0 949 444, U.S. Pat. No. 4,924,679, DE-A-100 31 491, DE 692 02 950 T2, DE 195 11 383 A1, DE 196 41 647 C1, DE 695 19 354 T2, DE-A-20 13 983 and WO 2005/043028.

Printed publication DE-A-31 03 587 describes a thermally insulated hose having a complex construction. Foam in particular is proposed as insulation material.

However, this printed publication does not disclose a system whose insulation can be improved by the use of vacuum.

A hose system which can be operated under vacuum is disclosed in DE-A-36 30 399. However, the vacuum is created by pumping. A powder bed in particular is described as insulation material. To conduct the gas out of the hose, a batt material which is pressed against the bed during the application of vacuum is disclosed.

A flexible cryogenic hose for transporting cold media, more particularly for transporting liquefied gases, is depicted in EP-A-0 949 444. However, only the use of fluoropolymers is described herein, and the use of fibres composed of this material is not disclosed. On the contrary, spacers, more particularly tapes or discs composed of these polymeric materials are described.

The use of CO₂ for creating a vacuum within a line system is disclosed in U.S. Pat. No. 4,924,679. However, the material proposed is likewise the use of fluorohoses without anything pointing to fibre materials being disclosed in this printed publication.

DE-A-100 52 856 proposes using the heat of vaporization of the cryogenic medium for cooling and liquefying a medium (air for example) which stores energy through phase transition. This appreciably lengthens the storage life of the cryogenic medium. In the course of filling and removing cryogenic medium from the storage container, recourse is had to the energy-storage medium in order that the energy balance relating to storage may be improved.

Similarly, the use of multiple energy generation storage supply grid household technology solar/environmental heat energy recovery systems has already been described. An example thereof is found in DE-A-100 31 491. However, this document discusses multiple ways of embodying such systems in very general terms only.

DE 692 02 950 T2 describes a transfer line for a cryogenic fluid. This transfer line includes thermally coupled pipework lines for transportation of cryogenic fluid and of a cooling fluid, which are wrapped with a foil which is connected to the cooling pipework line using connecting means.

DE 195 11 383 A1 discloses a natural gas liquification process which is coupled to a vaporization process for cryogenic liquids. A further development of this process is described in DE 196 41 647 C1 30.

DE 695 19 354 T2 discloses a liquid cryogen delivery system with subcooler.

DE-A-20 13 983 discloses a line system for transferring electric energy, cooling power or for transportation of industrial gases which is useable for constructing an extensive line grid having different functionalities.

Finally, the printed publication WO 2005/043028 describes a line component for an energy grid and a process for supplying consumers with cryogenic energy media.

The printed publications discussed above already describe line systems which can be used for transportation of cryogenic energy media. However, there is an enduring need to improve the properties of these line systems.

Some of the systems discussed above describe pipework lines fabricated from a rigid material. However, these insulation materials are not simple to conform to components to be insulated that have complex shapes. As early as when the vacuum is being applied, the later shape of the component to be enclosed has to be predetermined. It is thus also not possible in practice to realize complete enclosure of a component without edges or seams which extend in the heat transfer direction (so-called heat bridges). The sometimes excellent insulating properties of such insulated components in the area thereof thus are compromised in practical use by numerous unavoidable heat bridges at the transitions from one insulated component to the next. The overall effective insulating performance of a stretch of pipework for cryogenic gases that is insulated in this way is therefore typically distinctly too bad for transportation over prolonged stretches. In addition, owing to the stiffness of these insulated components, their processing is often difficult and geometrically greatly constrained.

One way to insulate complex-shaped components is to surround them all over with a shell which is sealable gastight, to fill the void space between the shell and the component with a bed (consisting of powders) and then to lower the gas pressure starting within this shell. However, the problem is that of a defined position, more particularly an ideally midpoint centring within the shell of the component to be insulated, since powder beds, although capable of being introduced into angulated void spaces as well, scarcely offer support for heavy or mobile components. Such beds behave somewhat like liquids, so that the component to be insulated is easy to displace to the edge of the shell with the result that locally an excessively thin insulating layer is produced. Suitable spacers are the only remedy, but they in turn constitute heat bridges and, on the other hand, make the entire construction very complex and difficult to process.

These bendable systems are described inter alia in WO 2005/043028, the insulation of which fails to meet many requirements. To insulate these bendable systems, WO 2005/043028 proposes the use of foamed plastics, silica powders or mineral fibres. However, foamed plastics have a relatively high thermal conductivity. Mineral fibres, asbestos for example, must be avoided for health reasons. In the case of silica powders, the insulating performance can decrease in the event of improper installation of the line system. The use of polymeric fibres as insulation material is not disclosed in WO 2005/043028. However, many of these insulation materials display similar disadvantages to the foamed plastics discussed above.

Insulation materials based on polymeric fibres are described in the U.S. Pat. No. 4,588,635, U.S. Pat. No. 4,681,789, U.S. Pat. No. 4,992,327 and U.S. Pat. No. 5,043,207 patents to Albany International Corp., Albany, N.Y. (USA). However, the examples merely contain observations concerning PET batts which used as insulation materials in the line systems discussed above generally do not lead to superior properties than the foamed plastics discussed above. The combination of high-performance fibres with bonding fibres, which are subject matter of the present fibre assembly, is not explicitly disclosed in these printed publications.

In view of the prior art herein indicated and discussed, it is an object of the present invention to provide an insulation material which has an excellent portfolio of properties.

This portfolio of properties comprises more particularly a very low thermal conductivity on the part of the material and good mechanical properties which are maintained at low temperatures. The mechanical properties include more particularly that the material has high strength in relation to confining pressure and high elasticity at high and low temperatures in order, for example, that defined positioning of the inner lines may be ensured, so that the insulating properties are essentially preserved. Furthermore, a line plus insulation should exhibit sufficient bendability so that the line is simple to install safely.

We have found that these objects, as well as others which, although not actually mentioned explicitly, can be inferred as obvious from the contexts discussed here or are necessarily apparent therefrom, are achieved by the fibre assembly described in Claim 1. Advantageous modifications of this fibre assembly are protected in the subclaims referring back to Claim 1. With regard to an insulation system and also the use, Claims 22 and 36 respectively provide a solution to the underlying problems.

The present invention accordingly provides a fibre assembly comprising high-performance polymeric fibres and bonding fibres, the fibre assembly comprising at least 70% by weight of high-performance polymeric fibres and at most 30% by weight of bonding fibres, characterized in that the fibre assembly has a layered arrangement of the fibres, at least some of the fibres being bonded together by points of contact obtainable by softening of the bonding fibres.

The measures of the present invention surprisingly succeed in providing an insulation material having an excellent portfolio of properties.

A fibre assembly according to the present invention exhibits a very low thermal conductivity on the part of the material and good mechanical properties which are maintained at low temperatures. Mechanical properties include more particularly that the fibre assembly processed has high strength with regard to a confining pressure and high elasticity at high and low temperatures. Accordingly, the fibre assembly is able to provide a line which conducts a cryogenic energy medium with sufficient support so that a defined positioning of these lines is maintained at installation and at operation. Furthermore, lines comprising a fibre assembly according to the present invention can have sufficient bendability so that the lines are simple to install safely.

In addition, present invention fibre assemblies and insulation systems comprising these fibre assemblies are simple and inexpensive to produce and process.

A fibre assembly of the present invention comprises high-performance polymeric fibres and bonding fibres. High-performance polymeric fibres are known to those skilled in the art. The term is to be understood as meaning more particularly polymeric fibres which can be used at high temperatures. The polymeric materials comprising these fibres preferably have low solid-state thermal conductivities, are very elastic and hard, chemical resistant, of low flammability, and have a relatively high IR extinction coefficient.

The high-performance polymeric fibres preferably have a melting point or a glass transition temperature of at least 200° C. and more preferably at least 230° C. This property can be measured by means of differential scanning calorimetry (DSC).

The solid-state thermal conductivity of preferred polymeric materials for producing high-performance polymeric fibres is preferably at most 0.7 W/(mK), more preferably at most 0.2 W/(mK), for example measured as per ASTM 5930-97 or DIN 52616 at a temperature of 293 K.

Preferred high-performance polymeric fibres include inter alia polyimide fibres, polybenzimidazole fibres, polyaramid fibres, polyether ketone fibres and/or polyphenylene sulfide fibres, of which polyimide fibres are particularly preferred.

Polyimides are known per se and described for example in Ullmann's Encyclopedia of Industrial Chemistry 5th edition on CD-ROM.

Polyimides may preferably have a weight average molecular weight in the range from 25 000 to 500 000 g/mol.

Preferred polyimides are obtainable by condensation of anhydrides with amines and/or isocyanates. Preferably, an at least bifunctional anhydride is reacted with an at least bifunctional isocyanate in strongly polar aprotic solvents such as, for example, NMP, DMF, DMAc or DMSO by elimination of CO₂. Alternatively, an at least bifunctional anhydride can be reacted with an at least bifunctional amine, in which case the polyamide acid intermediates have to be imidated in a second stage. This imidation is traditionally carried out thermally at temperatures above 150 to 350° C. or chemically with the assistance of water-withdrawing agents such as acetic anhydride and a base such as pyridine at room temperature.

Preferred monomeric building blocks for preparing the polyimides comprise inter alia aromatic diisocyanates, more particularly 2,4-diisocyanatotoluene (2,4-TDI), 2,6-diisocyanatotoluene (2,6-TDI), 1,1′-methylenebis[4-isocyanatobenzene](MDI), 1H-indene-2,3-dihydro-5-isocyanato-3-(4-isocyanatophenyl)-1,1,3-trimethyl (CAS 42499-87-6); aromatic acid anhydrides, for example 5, 5′-carbonylbis-1,3-isobenzofurandione (benzophenonetetracarboxylic dianhydride, BTDA), pyromellitic anhydride (PMDA). These monomeric building blocks can be used alone or as a mixture.

It is a particular aspect of the present invention that the polyimide used can be a polymer obtainable from the reaction of a mixture comprising 5,5′-carbonylbis-1,3-isobenzofurandione (BTDA) with 2,4-diisocyanatotoluene (2,4-TDO, 2,6-diisocyanatotoluene (2,6-TDI), 1,1′-methylenebis[4-isocyanatobenzene] (MDI). The proportion of BTDA here is preferably at least 70 mol %, more preferably at least 90 mol % and even more preferably about 100 mol %, based on the acid anhydrides used. The proportion of 2,4-TDI here is preferably at least 40 mol %, more preferably at least 60 mol % and even more preferably about 64 mol %, based on the diisocyanates used. The proportion of 2,6-TDI in this embodiment is preferably at least 5 mol %, more preferably at least 10 mol % and even more preferably about 16 mol %, based on the diisocyanates used. The proportion of MDI in this embodiment is preferably at least 10 mol %, more preferably at least 15 mol % and even more preferably about 20 mol %, based on the diisocyanates used.

Preferably, the polyimide used may further be a polymer obtainable from the reaction of a mixture comprising 5,5′-carbonylbis-1,3-isobenzofurandione (BTDA) and pyromellitic anhydride (PMDA) with 2,4-diisocyanatotoluene (2,4-TDI) and 2,6-diisocyanatotoluene (2,6-TDI). The proportion of BTDA here is preferably at least 40 mol %, more preferably at least 50 mol % and even more preferably about 60 mol %, based on the acid anhydrides used. In this embodiment, the proportion of pyromellitic anhydride (PMDA) is preferably at least 10 mol %, more preferably at least 20 mol % and even more preferably about 40 mol %, based on the acid anhydrides used. The proportion of 2,4-TDI in this embodiment is preferably at least 40 mol %, more preferably at least 60 mol % and even more preferably about 64 mol %, based on the diisocyanates used. The proportion of 2,6-TDI in this embodiment is preferably at least 5 mol %, more preferably at least 10 mol % and even more preferably about 16 mol %, based on the diisocyanates used.

In addition to homopolymers, useful polyimides further include copolymers which, in addition to the imide building blocks, comprise further functional groups in the main chain. It is a particular aspect of the present invention that the polyimides can be at least 50% by weight, preferably at least 70% by weight and even more preferably at least 90% by weight derived from monomeric building blocks leading to polyimides.

Particularly preferred polyimides are commercially available under the trade name P84 from Inspec Fibres GmbH, Lenzing/Austria or from HP-Polymer GmbH, Lenzing/Austria and under the name Matrimid from Huntsman Advanced Materials GmbH/Bergkamen.

In a preferred embodiment, the high-performance polymeric fibres may have a non-circular cross-sectional shape. Non-circular cross-sectional shapes generally have bulges and indentations. A bulge is a bounding of the fibre in the transverse direction at a maximum distance from the fibre's centre of gravity, while an indentation is a bounding of the fibre at a minimum distance from the fibre's centre of gravity. The bulges and indentations are accordingly local maxima and minima, respectively, of the separation of outer bounding of the fibre and the fibre's centre of gravity. The largest distance from the centre of gravity of the fibre to at least one of the bulges can be regarded as outer radius of the fibre's cross section. It is similarly possible to define an inner radius as the minimum distance between the centre of gravity of the fibre and at least one indentation. The ratio of outer radius to inner radius is preferably at least 1.2, more preferably at least 1.5 and even more preferably at least 2. The cross-sectional shape of the fibres and also the extent can be determined via electron microscopy.

These non-circular cross-sectional shapes include more particularly multilobal cross sections and star-shaped cross sections which have three, four, five, six or more bulges. It is particularly preferred for the fibre to have a trilobal cross section. Polyimide fibres having a non-circular cross section, more particularly a trilobal cross section, are obtainable in particular by using a solution having a relatively low polymer content in the customary solution spinning processes.

Hollow fibres can be used as well as solid fibres. Preferred hollow fibres likewise have a non-circular cross-sectional shape, more particularly a trilobal cross-sectional shape.

The high-performance fibres can be used as staple fibre or as continuous filament.

The diameter of the high-performance polymeric fibres is preferably in the range from 1 to 50 μm, more preferably in the range from 2 to 25 μm and even more preferably in the range from 3 to 15 μm. The diameter here refers to the maximum extent of the fibre in the transverse direction which is measured through the centre of gravity. The diameter can be determined inter alia using electron microscopy (SEM).

The linear density of the high-performance polymeric fibres may preferably be at most 10 dtex and more preferably at most 5 dtex. The linear density of the high-performance polymeric fibres is preferably in the range from 0.05 to 4 dtex and more preferably in the range from 0.1 to 1 dtex, measured at the maximum extent.

It is a particular aspect of the present invention that it is possible to use high-performance fibres having a crimp. The crimp may preferably be in the range from 1 to 50 and more preferably in the range from 3 to 10 per cm. Fibre crimp can be determined via optical methods. These values frequently result from manufacture.

A further preferred embodiment may utilize high-performance fibres having only minimal if any crimp.

In addition to high-performance polymeric fibres, a fibre assembly according to the present invention comprises bonding fibres, used to bond the high-performance polymeric fibres together. The bonding fibres preferably have a melting point or a glass transition temperature of at most 180° C. and more preferably of at most 150° C. The melting point or the glass transition temperature can be determined via DSC.

The bonding fibres preferably comprise polyolefin fibres, acrylic fibres, polyacetate fibres, polyester fibres and/or polyamide fibres.

The diameter of the bonding fibres is preferably in the range from 1 to 50 μm, more preferably in the range from 2 to 20 μm and even more preferably in the range from 4 to 10 μm. Diameter here refers to the maximum extent of the fibre in the transverse direction measured through the centre of gravity.

The linear density of preferred bonding fibres is preferably less than 10 dtex, more preferably less than 5 dtex. The linear density of preferred bonding fibres is preferably in the range from 0.05 to 4 dtex and more preferably in the range from 0.1 to 2 dtex, measured at the maximum extent.

The fibre assembly comprises at least 70% by weight of high-performance polymeric fibres and at most 30% by weight of bonding fibres. The proportion of high-performance polymeric fibres is preferably in the range from 75% by weight to 99.5% by weight and more preferably in the range from 80 to 95% by weight. The upper limit to the proportion of bonding fibres results from the required performance capability on the part of the fibre assembly, while the lower limit results from the requirements dictated by the manufacturing methods of the insulation systems. The proportion of bonding fibres is preferably in the range from 0.5% by weight to 25% by weight and more preferably in the range from 5% by weight to 20% by weight.

The fibre assembly has a layered arrangement of the fibres, at least some of the fibres being bonded together by points of contact obtainable by softening of the bonding fibres.

The term “layered arrangement of the fibres” is to be understood as meaning that the fibres have a main orientation which is essentially in a plane. Here the term “plane” is to be understood as having a wide meaning, since the fibres have a three-dimensional extent and the plane can also be curved. The term “essentially” is accordingly to be understood as meaning that the main orientation of the fibres is such that a very low proportion of the fibres is oriented in the direction of a heat gradient. The main orientation results from the direction of the fibres which is averaged along the length of the fibre, minor directional changes being disregardable.

A layered arrangement within this meaning is generally achieved in the production of webs or batts. In these processes, filaments or staple fibres are arranged in a plane and subsequently consolidated. This can be effected for example by air-laid processes or by wet-laid processes. Preferably, only a few fibres have a main orientation perpendicular to this plane. Accordingly, the fibre assembly is generally not consolidated by marked needling.

The fibre assembly is obtained by softening and subsequent cooling of the bonding fibres. Processes relating thereto are described more particularly in the U.S. Pat. No. 4,588,635, U.S. Pat. No. 4,681,789, U.S. Pat. No. 4,992,327 and U.S. Pat. No. 5,043,207 patents to Albany International Corp., Albany, N.Y. (USA). The temperature depends more particularly on the softening temperature (glass transition temperature or melting temperature) of the bonding fibres. It is frequently not necessary here for all fibres to be bonded together by points of contact obtainable by softening of the bonding fibres. The higher this proportion, the better the mechanical properties possessed by the assembly. However, the thermal conductivity of the assembly may increase. It may be mentioned in this connection that the fibres in the assembly may also have points of contact which were not obtained by softening of the bonding fibres. These include more particularly points at which the high-performance polymeric fibres touch.

Within a plane of the layered arrangement, the fibres may preferably have a main orientation, in which case the main orientation of fibres of different planes more preferably form an angle with each other. The expression “main orientation of the fibre” results from the average orientation of the individual fibre over its total length. The angle which the oriented fibres of different planes can have relative to each other is preferably in the range from 5° to 175° and more preferably in the range from 60° to 120°. The main orientation of the fibres and also the angles of the fibres of different planes relative to each other can be determined via optical methods. Frequently, these values result from manufacture in that the orientation of fibres can be predetermined by carding for example.

A low density is frequently associated with a particularly low thermal conductivity on the part of the fibre assembly. On the other hand, the strength of the fibre assembly decreases as a result of low density, so that stability can frequently become too low to offer sufficient support to a line conducting a cryogenic energy medium. It is therefore a surprising advantage for a fibre assembly according to the present invention, used in an insulation material for example, to preferably have a density in the range from 50 to 300 kg/m³, more preferably 100 to 150 kg/m³, these values being measured under a load dictated by the processing and the incorporation into the insulation material. This load transversely to the plane of the main orientation of fibres to which these density values apply is for example in the range from 1 mbar to 1000 mbar, these density values being measurable for example at a load of 1 mbar, 10 mbar, 50 mbar, 100 mbar, 200 mbar, 400 mbar, 600 mbar, 800 mbar or 1000 mbar.

In the unloaded state, more particularly prior to processing, the fibre assembly can preferably have a density in the range from 1 to 30 kg/m³ and more preferably 5 to 20 kg/m³, in which case this density can be measured at a thickness for the unprocessed fibre assembly which is not more than 5 cm.

The average thermal conductivity of a fibre assembly according to the present invention when measured perpendicularly to the planes of the layered arrangement is preferably at most 10.0*10⁻³ W(mK)⁻¹, more preferably at most 5.0 mW(mK)⁻¹ and even more preferably at most 1.0*10⁻³ W(mK)⁻¹. The measurement can be carried out for example at room temperature (293 K) and/or at low temperatures, for example 150 K or 77 K, in which case the material withstands a load under these conditions for at least 14 days. The test is preferably carried out at a low absolute pressure, for example at a pressure of 1 mbar or less as per DIN EN 12667 (“Determination of thermal resistance by means of guarded hot plate and heat flow meter methods”). The determination can be carried out for example at a gas pressure of 0.01 mbar within the fibre assembly to be measured and at a confining pressure of 70 mbar exerted by the measuring apparatus on the fibre assembly transversely to the plane of the main orientation of the fibres.

The thermal conductivity values recited above are achievable more particularly because there is only minimal heat transfer perpendicularly to the fibre plane of the layered arrangement. Therefore, it is preferable to dispense with any marked needling or with any consolidation using a high amount of liquid binders which can lead to heat or cold bridges perpendicularly to the layered arrangement of fibre. However, minimal needling or the use of minimal amounts of liquid binders is possible provided these measures only lead to a minimal increase in thermal conductivity.

It is particularly preferable that a fibre assembly according to the present invention has high stability including in the direction perpendicularly to the plane of the main orientation of the fibres. A fibre assembly according to the present invention has in the processed state and/or in the insulation material a relatively low compressibility which is preferably at most 50% when the load increases by 1 mbar; that is, when the load increases by 1 mbar, the thickness of the fibre assembly decreases by at most 50%, preferably by at most 30%, more preferably by at most 10% and even more preferably by at most 5%, based on the original thickness of the processed assembly.

A fibre assembly according to the present invention can be used more particularly as an insulation material, preferably in vacuum insulation systems. Accordingly, insulation systems, more particularly vacuum insulation systems, that include the fibre assemblies described above likewise form part of the subject matter of the present invention.

By vacuum insulation system is meant a thermally insulated system whose insulating performance is improved by vacuum. Vacuum is to be understood as meaning in this connection that the absolute pressure in the system is preferably not more than 500 mbar, more preferably not more than 50 mbar and even more preferably not more than 1 mbar. As a result, the thermal conductivity of the system is greatly reduced.

Vacuum insulation systems are described inter alia in DE-A-36 30 399, EP-A-0 949 444, U.S. Pat. No. 4,924,679, DE-A-100 31 491, DE 692 02 950 T2, DE 195 11 383 A1, DE 196 41 647 C1, DE 695 19 354 T2, DE-A-20 13 983 and WO 2005/043028.

The vacuum can be generated for example mechanically, more particularly by means of a vacuum pump. Preferably, the vacuum can form as a result of a fluid in the vacuum system, more particularly a gas, undergoing solidification or condensation. More particularly, the fluid can be solidified or condensed by being cooled. Preferred fluids include more particularly nitrogen, oxygen, carbon dioxide and/or volatile hydrocarbons having a boiling point of below 0° C. at 1 bar. Volatile hydrocarbons include methane, ethane, propane and/or butane.

Preferred vacuum insulation systems are used more particularly for transportation of cryogenic fluids, more particularly liquids. “Cryogenic fluid” is to be understood as referring to a cold fluid which preferably has a temperature of at most −40° C., more preferably at most −100° C. and even more preferably −150° C. or less. These vacuum insulation systems comprise at least one line or line assembly in which a cryogenic fluid can be transported.

The line assembly refers in the context of the present invention to a system comprising at least two different lines. For instance, the line assembly may include two or more inner lines capable of transporting liquids or gases. In addition, the line assembly may also comprise at least one inner line for the transportation of liquids and/or gases and at least one data and/or electric power line. Particularly preferred line assemblies comprise at least two inner lines for transportation of the material and at least one data and/or electric power line.

In general, these lines or line assemblies comprise at least one inner line and an outer sheath, the cryogenic fluid being conducted through the inner line and the outer sheath shutting the line off from the environment, so that a vacuum can form between the inner line and the outer sheath. Accordingly, the outer sheath serves more particularly to maintain the insulating effect.

Preferably, the line or line assembly has a rounded-off, for example a circular or elliptical cross-sectional shape, in which case not only at least one of the inner lines but also the outer sheath can have a rounded-off, for example circular or elliptical cross-sectional shape.

It is a particular aspect of the present invention that the line assembly of the vacuum system may comprise at least two inner lines, one inner line being provided for conducting away gases and/or for conducting an energy transfer medium.

To improve insulating performance, the outer sheath can be given a coat of metal. This coat of metal can be applied for example by a vapour deposition of metal, via a metal-containing lacquer or via a metal foil. This can take place on the outer surface, on the inner surface or both.

In many cases, a small diameter is sufficient to transfer a sufficient amount of cryogenic fluid. The inner diameter of the inner line is therefore preferably not more than 50 mm, preferably not more than 20 mm, more preferably not more than 10 mm and even more preferably not more than 5 mm.

Appropriate choice of material can serve to render the line or line assembly of the vacuum system bendable at room temperature. The materials more particularly to produce the inner line and the outer sheath are general common knowledge and more particularly are recited in the printed publications cited above. Preferably, the line or line assembly of an insulation system according to the present invention can have a bending radius of at most 20 m, more preferably at most 10 m, more preferably at most 5 m and even more preferably at most 1.5 m. The bending radius results from the maximum curvature which can be achieved without damaging the line or line assembly. Damaging means that the system is no longer fit for purpose.

In addition to a line system, an insulation system according to the present invention, more particularly a vacuum insulation system may comprise further components. These include more particularly heat exchangers, pumps, control systems and feed or removal systems. The control systems may more particularly also comprise components which can be inserted within the line system. Accordingly, these line systems may also comprise lines capable of transmitting electric signals.

Surprisingly, the properties of vacuum insulation systems can be improved by using high-performance polymeric fibres as insulation material. This surprisingly makes it possible to combine high insulating performance with simple and trouble-free processing of the system.

1. A fibre assembly comprising high-performance polymeric fibres and bonding fibres, wherein the fibre assembly comprises at least 70% by weight of high-performance polymeric fibres and at most 30% by weight of bonding fibres;
the fibre assembly has a layered arrangement of the fibres, wherein one or more of the fibres are bonded together by points of contact obtained by softening of the bonding fibres.

2. The fibre assembly according to claim 1, wherein the high-performance polymeric fibres have a melting point or a glass transition temperature of at least 200° C.

3. The fibre assembly according to claim 2, wherein the high-performance polymeric fibres comprise at least one of polyimide fibres, polybenzimidazole fibres, polyaramid fibres, polyether ketone fibres and polyphenylene sulfide fibres.

4. The fibre assembly according to claim 1, wherein the bonding fibres have a melting point or a glass transition temperature of at most 180° C.

5. The fibre assembly according to claim 4, wherein the bonding fibres comprise at least one of polyolefin fibres, acrylic fibres, polyacetate fibres, polyester fibres and polyamide fibres.

6. The fibre assembly according to claim 1, wherein the high-performance polymeric fibres have a diameter in the range from 1 to 50 μm.

7. The fibre assembly according to claim 1, wherein the high-performance polymeric fibres have a linear density in the range from 0.05 to 10 dtex.

8. The fibre assembly according to claim 1, wherein the bonding fibres have a diameter in the range from 1 to 50 μm.

9. The fibre assembly according to claim 1, wherein the bonding fibres have a linear density in the range from 0.05 to 10 dtex.

10. The fibre assembly according to claim 1, wherein the fibre assembly has a density in the range from 50 to 300 kg/m³.

11. The fibre assembly according to claim 1, wherein the fibres within the planes of the layered arrangement have a main orientation.

12. The fibre assembly according to claim 11, wherein the orientations of the fibres of different planes form an angle relative to each other.

13. The fibre assembly according to claim 12, wherein the angle formed by the oriented fibres of different planes is in the range from 5 to 175°.

14. The fibre assembly according to claim 1, wherein the high-performance polymeric fibres have a non-circular cross-sectional shape.

15. The fibre assembly according to claim 14, wherein the high-performance polymeric fibres have a trilobal cross-sectional shape.

16. The fibre assembly according to claim 14, wherein the cross-sectional shape comprises bulges and indentations and the bulges form an outer radius and the indentations form an inner radius, the ratio of outer radius to inner radius being at least 1.2.

17. The fibre assembly according to claim 1, wherein an average thermal conductivity measured perpendicularly to planes of the layered arrangement is at most 10.0*10⁻³ W(mK)⁻¹.

18. The fibre assembly according to claim 1, wherein the high-performance fibres have a crimp.

19. The fibre assembly according to claim 18, wherein the crimp is in the range from 3 to 10 per cm.

20. An insulation material comprising the fibre assembly according to claim 1.

21. The insulation material according to claim 20, wherein the fibre assembly is used in a vacuum insulation system.

22. An insulation system comprising the fibre assembly according to claim 1.

23. The insulation system according to claim 22, wherein the insulation system is a vacuum insulation system.

24. The insulation system according to claim 22, wherein the vacuum is formed by a fluid in the vacuum system undergoing solidification or condensation.

25. The insulation system according to claim 22, wherein the fluid comprises nitrogen, oxygen, carbon dioxide and/or a volatile hydrocarbon.

26. The insulation system according to claim 22, wherein the vacuum insulation system comprises at least one line in which a cryogenic fluid can be transported.

27. The insulation system according to claim 26, wherein the line comprises at least one inner line and an outer sheath, the cryogenic fluid being conducted through the inner line and the outer sheath shutting the line off from the environment, so that a vacuum can form between the inner line and the outer sheath.

28. The insulation system according to claim 26, wherein the line is a line assembly.

29. The insulation system according to claim 28, wherein the line assembly comprises at least two inner lines, one inner line being provided for conducting away gases and/or for conducting an energy transfer medium.

30. The insulation system according to claim 28, wherein the line assembly comprises at least one data and/or electric power line.

31. The insulation system according to claim 27, wherein the outer sheath bears a coat of metal.

32. The insulation system according to claim 27, wherein the inner diameter of the inner line is not more than 50 mm.

33. The insulation system according to claim 27, wherein the line is bendable at room temperature.

34. The insulation system according to claim 33, wherein the bending radius is at most 20 m.

35. The insulation system according to claim 22, wherein the insulation system includes at least one heat exchanger.

36. An insulation material in a vacuum insulation system comprising high performance polymeric fibres.

37. The insulation material according to claim 36, wherein the high-performance polymeric fibres comprise at least one of polyimide fibres, polybenzimidazole fibres, polyaramid fibres, polyether ketone fibres and polyphenylene sulfide fibres.
